(19) United States
(12) Patent Application Publication
(10) Pub. No.: US 2021/0340661 A1
(43) Pub. Date: Nov. 4, 2021

(54) Hybrid Washer and Method of Manufacture

(71) Applicant: John Eric Chapman, Gray, TN (US)

(72) Inventor: John Eric Chapman, Gray, TN (US)

(21) Appl. No.: 17/372,666

(22) Filed: Jul. 12, 2021

Related U.S. Application Data
(63) Continuation-in-part of application No. 16/973,802, filed on Dec. 10, 2020.
(60) Provisional application No. 62/683,395, filed on Jun. 11, 2018.

(51) Int. Cl. C23C 8/80; B22F 3/24; C23C 8/34; B22F 3/11; F16B 43/00

(52) U.S. Cl. CPC C23C 8/80; B22F 3/24; C23C 8/34; B22F 1/0011; F16B 43/00; B22F 2003/248; B22F 3/11

(57) ABSTRACT

Metal powder is compacted in a die to produce a preform having a preselected porosity with the metal powder containing iron and having a plurality of particles having a preselected particle sizes. The preform is carburized to produce a high carbon solution in the metal powder. The preform is contacted with an ammonia gas distillation solution to inject nitrogen therein. The preform is heat treated for a predetermined period of time at a predetermined temperature and at a predetermined pressure. The preform is quenched to form a metal part.

### CROSS REFERENCE TO RELATED APPLICATION

The present application is a continuation-in-part of U.S. patent application Ser. No. 16/973,802, filed Dec. 10, 2020, which is a U.S. national stage application of PCT International Application No. PCT/US2019/036249, filed Jun. 10, 2019, and published as PCT Publication WO/2019/241097 on Dec. 19, 2019, which claims priority to U.S. Patent Application No. 62/683,395, filed on Jun. 11, 2018. The disclosures of all the foregoing applications are hereby incorporated by reference in their entirety into the present application.

### BACKGROUND

Conventional washers are disc shaped objects that include a pair of essentially parallel, flat surfaces with a central hole for a screw shank. The essentially flat characteristic of the parallel surfaces does not facilitate the engagement of one washer to another washer for locking purposes. The conventional washers can be manufactured from a strip blank that is fed to pass several forming or punching stations. The punching stations can utilize various upper and lower tools. In some arrangements, the pattern of teeth can be formed on and can cover, substantially, an upper surface. A pattern of cams can formed on and can cover, substantially, the lower surface of the washer.

These conventional washer fabrication processes have several disadvantages and problems. For example, undesired displacements can occur between the stations during feeding in the die arrangement to cause the formation of defective washers. In some instances, the total amount of blank material can be quite high. Furthermore, there can be restrictions related to the cam and teeth cover on each side of the washers, which decreases the possibility of forming load bearing surfaces. Also, the outer periphery can be punched out and can receive a sharp edge, which causes problems in the further processing of the washer.

Another type of washer is known as a locking washer. Such washers can be used in a locking system in which the washers are arranged in a pair with cam pattern sides facing and engaging each other. The main cam surface inclination can be larger than the pitch of the threads to cause a positive and efficient locking of a fastening element.

One particular type of locking washer arrangement involves a locking washer having teeth on one side and cams on the other side. The teeth can engage with a surface of a screw head, nut or an element to be attached. One possible shape is a leaning pyramidal shape. The teeth can extend, radially, on the locking washer surface. The other side of the known lock washers can have a cam pattern.

In some applications, locking washers are preferred over conventional washers. However, locking washers can have certain disadvantages, particularly involving excessive wear. For these reasons, there is a need for an improved washer.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

In various implementations, a method of producing a metal part is provided. A metal powder is compacted in a die to produce a preform having a preselected porosity with the metal powder containing iron and having a plurality of particles having a preselected particle sizes. The preform is carburized to produce a high carbon solution in the metal powder. The preform is contacted with an ammonia gas distillation solution to inject nitrogen therein. The preform is heat treated for a predetermined period of time at a predetermined temperature and at a predetermined pressure. The preform is quenched to form the metal part.

In other implementations, a method of producing a hybrid washer is provided. A metal powder is compacted in a die to produce a preform having a preselected porosity with the metal powder containing iron and having a plurality of particles having a preselected particle sizes. The preform is carburized to produce a high carbon solution in the metal powder. The preform is contacted with an ammonia gas distillation solution to inject nitrogen therein. The preform is heat treated for a predetermined period of time at a predetermined temperature and at a predetermined pressure. The preform is quenched to form the hybrid washer.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is a perspective view of a hybrid washer in accordance with this disclosure.

FIG. 2A is a fragmentary side elevation view in cross section of a fastening system in accordance with this disclosure.

FIG. 2B is a fragmentary side elevation view in cross section of another embodiment of a fastening system in accordance with this disclosure.

FIG. 2C is a fragmentary side elevation view in cross section of another embodiment of a fastening system in accordance with this disclosure.

FIG. 2D is a fragmentary side elevation view in cross section of another embodiment of a fastening system in accordance with this disclosure.

FIG. 3 is a perspective view of another embodiment of a hybrid washer in accordance with this disclosure.

FIG. 4A is a perspective view of another embodiment of a hybrid washer in accordance with this disclosure.

FIG. 4B is a fragmentary perspective view of a surface for the embodiment of a hybrid washer shown in FIG. 4A.

FIG. 5 illustrates an embodiment of an exemplary process in accordance with the described subject matter.

FIG. 6 illustrates an embodiment of another exemplary process in accordance with the described subject matter.

### DETAILED DESCRIPTION

The subject disclosure is directed to new and improved hybrid washer for use in a fastening system and a method for manufacturing the hybrid washer. The hybrid washer includes an inner ring that has the configuration of a typical conventional washer and an outer ring that has the configuration of a locking washer with an engagement surface. The hybrid washer can be made through conventional methods, including conventional metal fabrication methods, or through powder metallurgy. In other embodiments, the hybrid washer or other metal parts can be made through an improved powder metallurgy process.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

The disclosure relates to a hybrid washer that can be used within a fastening system. The hybrid washer has all of the advantages of a conventional washer and a locking washer in a single washer. This can eliminate the need to keep two different types of washers for different applications within various types of fastening systems. Further, the hybrid washer can be useful in fastening systems within high vibration environments.

Another advantage of the disclosed subject matter is that the hybrid washer can be made through powder metallurgy processes. These processes can be more efficient than conventional washer fabrication methods because they can use less material and can be made from metal powders that use recycled materials. The use of powder metallurgy processes can allow the hybrid washer to be made from a wider variety of metals and metal alloys, including metals and metal alloys that cannot be fabricated into washers through conventional processes.

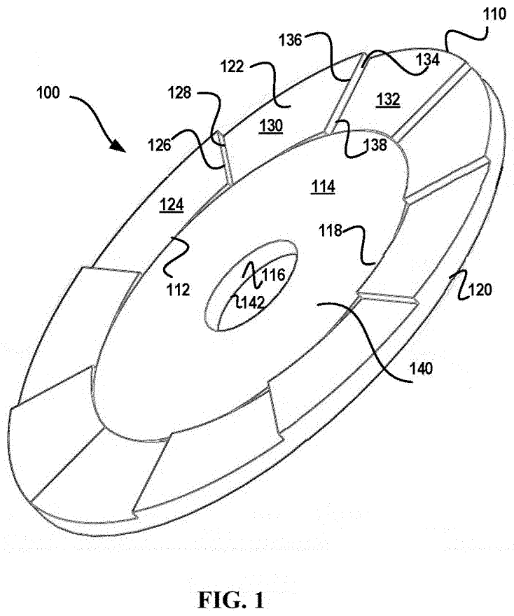

Referring to FIG. 1, a hybrid washer, generally designated by the numeral 100, in accordance with this disclosure is shown. The hybrid washer 100 has an essentially disk-shaped body 110 with an outer ring 112, an inner ring 114, and a bore 116 extending through the inner ring 114. The outer ring 112 can perform the functions of a locking washer. The inner ring 114 can perform the functions of a conventional washer.

The outer ring 112 is bound by a contoured outer edge 118 and a contoured inner edge 120. The contoured outer edge 118 represents the outer surface of the hybrid washer 110 and forms an outer rim for the hybrid washer 110. The contoured inner edge 120 represents a boundary between the outer ring 112 and the inner ring 114. The inner ring 114 is bound on the opposite side by the bore 116, which forms an inner rim for the hybrid washer 110.

The outer ring 112 has an engagement surface 122 that functions as a locking washer engagement surface. The engagement surface 122 includes a plurality of wedges 124. Each wedge 124 has a raised edge 126 and lowered edge 128. The wedges 124 are contoured to form a plurality of crests and troughs around the contoured outer edge 118 of the outer ring 112. The crests and troughs can enhance the ability of the outer ring 112 to engage other surfaces, frictionally.

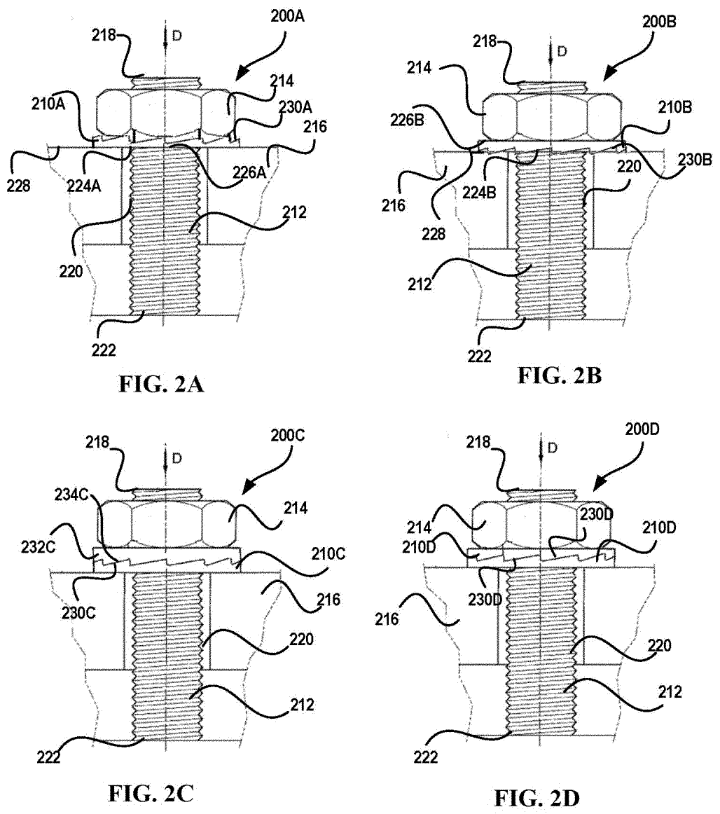

The wedges 124 abut one another to form a radial pattern on the engagement surface 122. Each raised edge 126 and lowered edge 128 extends radially and perpendicularly from a longitudinal axis, generally identified as D in FIGS. 2A-2D, projecting through the bore 116.

One exemplary wedge 130 is connected to an abutting wedge 132 by a face 134 that extends perpendicularly from the engagement surface 122. The face 134 is bound by the raised edge 136 on the wedge 130, the lowered edge 138 on the wedge 132, the contoured outer edge 118, and the contoured inner edge 120.

The inner ring 114 has a pair of essentially flat surfaces 140, 142 on opposite sides of the hybrid washer disc-shaped body 110. The essentially flat surfaces 140, 142 provide the inner ring 114 with the ability to function as a conventional washer.

The outer ring 112 and the inner ring 114 can be made from the same material or different materials. In some embodiments, the outer ring 112 and the inner ring 114 are unitary or integral and/or made from the same mass of material.

The outer ring 112 and the inner ring 114 can be made from can be made from any suitable material through any suitable manufacturing method. Suitable materials include flexible, semi-flexible, rigid, or semi-rigid materials. Suitable materials also include metals, ceramics, plastics, and composites. Specifically, suitable materials can include metals.

The metal is selected from the group consisting of carbon steel, spring steel, stainless steel, copper, brass, aluminum, titanium, iron, bronze, zinc, silicon bronze, Inconel, Monel, and Hastelloy.

Suitable manufacturing or fabrication methods generally fall into two categories. The first category of processes include the traditional forging and/or stamping processes in which the hybrid washer is formed from a square piece of wrought steel.

The second category of processes includes powder metallurgy processes, such as powder forging, hot isostatic pressing, metal injection molding, electric current assisted sintering, and additive manufacturing techniques. In such processes, powder metal can be stamped into a blank and put into an oven, so that the particles can be sintered together.

The powder metallurgy processes can be performed efficiently by using powder that contain a significant amount of recycled metal contents and by producing less waste material through the production of net shape or near-net shape products.

Referring now to FIGS. 2A-2D with continuing reference to the foregoing figures, various embodiments of a fastening system, generally designated by the numerals 200A-200D, are shown. The embodiments of the fastening systems 200A-200D include hybrid washers 210A-210D that have the ability to function as either a conventional washer or a locking washer. The hybrid washers 210A-210D are essentially identical to the hybrid washer 100 shown in FIG. 1.

The fastening systems 200A-200D include the hybrid washers 210A-210D, a shank member 212, a nut 214, and a bearing element 216. The shank member 212 connects the nut 214 to the bearing element 216. The nut 214 is positioned at one end 218 of the shank member 212. The bearing element 216 includes a hole 220 that receives the other end 222 of the shank member 212. In these exemplary embodiments, the shank member 212 is threaded and the bearing element hole 220 is configured to receive the threaded shank member 212.

Referring to FIG. 2A, an embodiment of the fastening system 200A is shown in which the hybrid washer 210A functions like a conventional washer between the nut 214 and the bearing element 216. The shank member 212 inserts through a bore 224A in the hybrid washer 210A. The bore 224A is essentially identical to the bore 116 shown in FIG. 1.

In this exemplary embodiment, a bottom surface 226A of the hybrid washer 210A abuts an upper surface 228 of the bearing element 216. The hybrid washer bottom surface 226A is an essentially flat surface that is essentially identical to the flat surface 142 shown in FIG. 1.

Unlike known fastening system that include a conventional washer, the fastening system 200A can be configured to have an engagement surface 230A frictionally engaging the nut 214 to provide an additional locking capability within the fastening system 200A. The frictional engagement of the engagement surface 230A against the nut 214 can lock or fix the shank member 212 into place between the nut 214 and the bearing element 216. The engagement surface 230A can be essentially identical to the engagement surface 122 shown in FIG. 1.

Referring to FIG. 2B, another embodiment of the fastening system 200B is shown in which the hybrid washer 210B functions like a locking washer between the nut 214 and the bearing element 216. The shank member 212 inserts through a bore 224B in the hybrid washer 210B. The bore 224B is essentially identical to the bore 116 shown in FIG. 1.

In this exemplary embodiment, the hybrid washer 210B is positioned in an upside down configuration in which an essentially flat hybrid washer bottom surface 226B engages the nut 214. The upper surface 228 of the bearing element 216 abuts an engagement surface 230B for the hybrid washer 210B to lock or to fix the shank member 212 in place.

The engagement surface 230B of the hybrid washer 210B can deform the upper surface 228 either permanently or temporarily when the hybrid washer 210B is made from a material that is harder than the material for which the bearing element 216 is made. The configuration is particularly useful when the bearing element 216 is made from wood or plastic and the hybrid washer 210B is made from a metal that is harder than wood or plastic.

Referring to FIG. 2C, another embodiment of the fastening system 200C is shown. The fastening system 200C is particularly adapted for applications in which there is a significant amount of vibration. In this exemplary embodiment, a hybrid washer 210C and a locking washer 232C are positioned between the nut 214 and the bearing element 216. The shank member 212 inserts through both the hybrid washer 210C and the locking washer 232C.

The hybrid washer 210C is with its engagement surface 230C facing the nut 214 and a mating surface 234C on the locking washer 232C facing the bearing element 216. The engagement surface 230C abuts the mating surface 234C, so that the surfaces are frictionally engaged.

The engagement surface 230C and the mating surface 234C can be contoured with a plurality of crests and troughs in the same manner in which the engagement surface 122 shown in FIG. 1 is contoured. In some embodiments, the mating surface 234C is contoured to form a plurality of crests for inserting into troughs on the engagement surface 230C. Similarly, the mating surface 234C can be contoured to form a plurality of troughs for receiving crests on the engagement surface 230C to lock the hybrid washer 210C against the locking washer 232C. In such embodiments, the engagement surface 230C and the mating surface 234C are interlocking, so that the hybrid washer 210C does not slip against the locking washer 232C, particularly when the environment includes a significant amount of vibration.

It should be understood that fastening system 200C can be configured with the hybrid washer 210C and the locking washer 232C in opposite positions. In such embodiments, the hybrid washer 210C abuts the nut 214 and the locking washer 232C abuts the bearing element 216. The engagement surface 230C abuts and frictionally engages the mating surface 234C.

Referring to FIG. 2D, another embodiment of the fastening system 200D is shown. Like the embodiment shown in FIG. 2C, the fastening system 200D is particularly adapted for applications in which there is a significant amount of vibration. Unlike the embodiment shown in FIG. 2C, the fastening system 200D includes two identical hybrid washers 210D positioned with the engagement surfaces 230D facing one another in abutment and in frictional engagement.

It should be understood that any of the fastening systems 200A-200D shown in FIGS. 2A-2D can be sold as individual components individually or in groups of individual components. It should also be understood that the fastening systems 200A-200D can be sold in kits in unassembled, partially assembled, or fully assembled form.

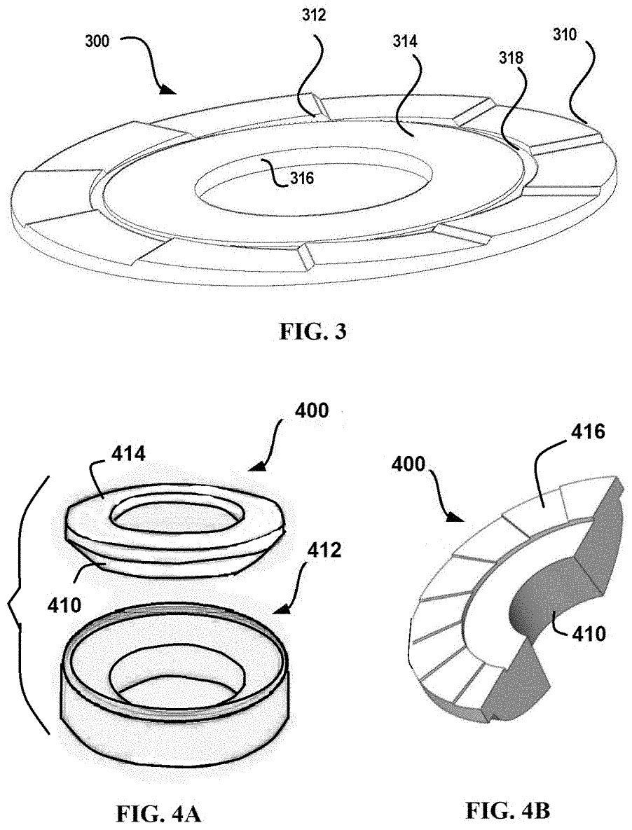

Referring to FIG. 3, another embodiment of a hybrid washer, generally designated by the numeral 300, in accordance with this disclosure is shown. Like the hybrid washer 100 shown in FIG. 1, the hybrid washer 300 has an essentially disk-shaped body 310 with an outer ring 312, an inner ring 314, and a bore 316 extending through the inner ring 314. The outer ring 312 can perform the functions of a locking washer. The inner ring 314 can perform the functions of a conventional washer.

Unlike the embodiment shown in FIG. 1, the hybrid washer 300 includes a recess 318 separating the outer ring 312 from the inner ring 314. In this exemplary embodiment, the recess 318 is essentially circular and is positioned between the outer ring 312 and the inner ring 314. The outer ring 312, the inner ring 314, the bore 316, and the recess 318 are essentially concentric with one another. The inclusion of the recess 318, which can be a drafted recess, can make it easier to fabricate the hybrid washer 300 using conventional tooling and/or fabrication methods.

Referring to FIGS. 4A-4B, another embodiment of a hybrid washer, generally designated by the numeral 400, in accordance with this disclosure is shown. Like the hybrid washer 100 shown in FIG. 1 and the hybrid washer 300 shown in FIG. 3, the hybrid washer 400 has an essentially disk-shaped body 410.

Unlike the embodiments shown in FIG. 1 and FIG. 3, the hybrid washer 400 is configured to be countersunk into a base 412. In this embodiment, the base 412 is a spherical countersunk base. As shown in FIGS. 4A-4B, an upper surface 414 of the hybrid washer 400 can include an engagement surface 416 that is similar in appearance with the outer ring 312 of the hybrid washer 300 shown in FIG. 3.

Further, it should be understood that, in some embodiments, the base 412 can include wedged on an upper surface to provide for use with a standard washer top.

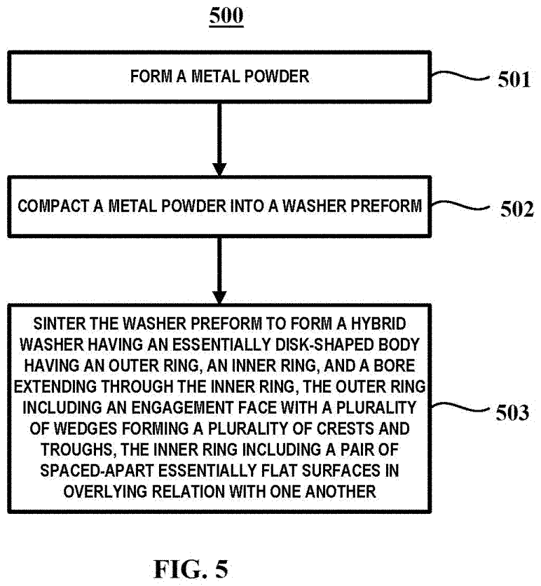

Referring to FIG. 5 with continuing reference to the foregoing figures, a method 500 for making a hybrid washer in accordance with the described subject matter is shown. In this exemplary embodiment, the hybrid washer is essentially identical to the hybrid washer 100 shown in FIG. 1 and the hybrid washers 210A-210D shown in FIGS. 2A-2D.

At 501, a metal powder is formed. In this exemplary embodiment, the metal powder can be formed of multiple metals to facilitate the formation of a hybrid washer that is formed from a metal alloy.

At 502, a metal powder is compacted into a washer preform. In this exemplary embodiment, the compacting step can be performed through any conventional or unconventional powder metallurgy compacting step. In some embodiments, Step 402 is performed in a flexible mold.

At 503, the washer preform can be sintered to form a hybrid washer having an essentially disk-shaped body having an outer ring, an inner ring, and a bore extending through the inner ring, the outer ring including an engagement surface with a plurality of wedges forming a plurality of crests and troughs, the inner ring including a pair of spaced-apart essentially flat surfaces in overlying relation with one another.

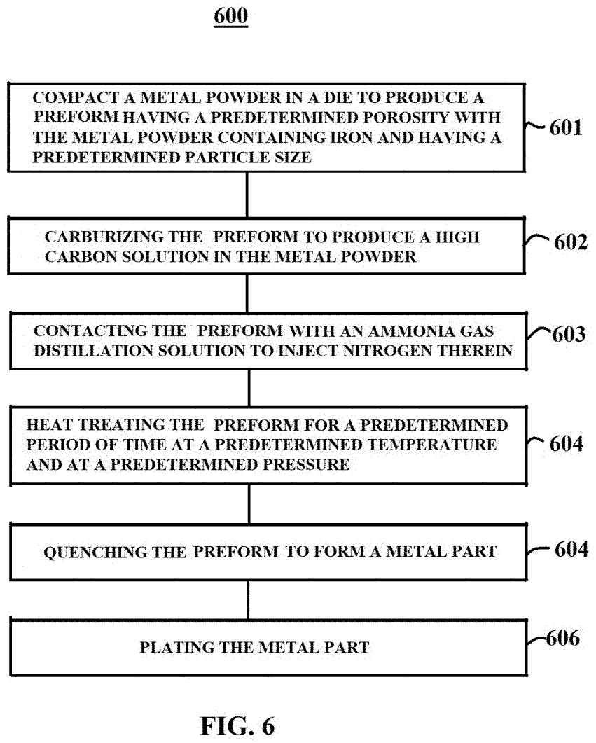

Referring to FIG. 6 with continuing reference to the foregoing figures, an improved powder metallurgy process 600 for making a metal part in accordance with the described subject matter is shown. In this exemplary embodiment, the metal part can be the hybrid washer 100 shown in FIG. 1, the hybrid washers 210A-210D shown in FIGS. 2A-2D, the hybrid washer 300 shown in FIG. 3 and/or the hybrid washer 400 shown in FIGS. 4A-4B. The metal part can include an iron nitride that is insoluble in water, so that the part has a high pitting resistance equivalent number (PREN).

The process 600 can utilize metal powder raw materials, such as iron powder, nickel powder, and chromium powder, as well as alloys thereof. The powder can include various additives, such as additives such as lubricant wax, carbon, and/or copper.

The process 600 can form metal parts that include various alloys and elemental metals, such as iron, iron alloys, nickel alloys, and chromium alloys. Suitable iron alloys include cast irons, gray irons, white irons, ductile irons, malleable irons, wrought iron, steels, crucible steels, carbon steels, spring steels, alloy steels, maraging steels, stainless steels, weathering steels, tool steels, and other specialty steels Suitable nickel alloys include chromel, ferronickel, hastelloys, inconels, monels, nichrome, and nickel-carbon alloys. Suitable chromium alloys include chromium hydride and ferrochrome. The alloys can be superalloys and/or high performance alloys.

At 601, a metal powder is compacted in a die to produce a workpiece or preform having a preselected porosity with the metal powder containing iron and having a plurality of particles having a preselected particle sizes. In some embodiments, the preselected porosity is within the range of about 5% and about 45%. In other embodiments, the preselected porosity is within the range of about 10% and about 35%. In yet other embodiments, the preselected porosity is within the range of about 15% and about 30%.

The plurality of particles can have preselected particle sizes within the range of about 25 micrometers and about 350 micrometers. The compacting step is performed by applying a pressure of between about 35 tons/sq in and about 75 tons/sq. in to the die. The compacting step produces a preform that has a porous surface to facilitate the formation of an iron nitride coating on the surface thereof.

In some embodiments, the process 600 produces a metal part having a thickness ranging from about 25 thousandths of inch to about 9 inches. It should be understood that the porosity of the powder that forms the preform can be matched to the thickness of the metal part.

At 602, the preform is carburized to produce a high carbon solution in the metal powder. The preform can be carburized using carbon diffusion technology that can harden the iron within the iron powder. Suitable carburizing processes include processes that utilize charcoal or as a gaseous carbon monoxide atmosphere to increase the carbon content of the material.

At 603, the preform is contacted with an ammonia gas distillation solution to inject nitrogen therein. In some embodiments, the ammonia gas distillation solution is formed with a gas having a concentration of ammonia falling within the range of about 15% to about 45%.

The ammonia gas distillation solution converts the iron within the iron powder into iron nitrides, at least partially. The porosity of the part allows the nitrogen within the ammonia gas distillation solution to penetrate the part into the core of the particles. The contacting step forms a pearlite microstructure having various iron oxide and iron nitride compounds, such as iron nitride (Fe4N), iron nitride (Fe8N), and iron nitride (Fe16N), therein.

At 604, the preform is heat treated for a predetermined period of time at a predetermined temperature and at a predetermined pressure. In some embodiments, the predetermined period of time falls within the range of about eight hours and about forty-eight hours. The predetermined temperature falls within the range of about 500 degrees Celsius and about 750 degrees Celsius. The predetermined pressure falls within the range of about 500 millibars and about 5000 millibars.

In some embodiments, the predetermined period of time is about twelve hours and the predetermined temperature is about 675 degrees Celsius. In other embodiments, the time, temperature, and pressure are selected based upon the alloy to form a part having a nitride layer at a case hardening depth.

At 605, the preform is quenched to form the metal part. The quenching step can be an oil quenching step.

At 606, the metal part is plated. The metal part can be plated with a metal selected from the group consisting of zinc, chromium, and nickel. In some embodiments, the metal part can be subjected to secondary machining and/or finishing operations.

The process 600 can be effective in forming hybrid washers having an engagement surface, such as hybrid washer 100 and engagement surface 122 shown in FIG. 1, hybrid washers 210A-210D and engagement surfaces 230A-230D shown in FIGS. 2A-2D, hybrid washer 300 shown in FIG. 3, and hybrid washer 400 and engagement surface 416 shown in FIGS. 4A-4B.

### Supported Features and Embodiments

The detailed description provided above in connection with the appended drawings explicitly describes and supports various features of a hybrid washer and a method for manufacturing the hybrid washer. By way of illustration and not limitation, supported embodiments include a method of producing a metal part, the method comprising: compacting a metal powder in a die to produce a preform having a preselected porosity with the metal powder containing iron and having a plurality of particles having a preselected particle sizes, carburizing the preform to produce a high carbon solution in the metal powder, contacting the preform with an ammonia gas distillation solution to inject nitrogen therein, heat treating the preform for a predetermined period of time at a predetermined temperature and at a predetermined pressure, and quenching the preform to form the metal part.

Supported embodiments include the foregoing method, wherein the quenching step is an oil quenching step.

Supported embodiments include any of the foregoing methods, wherein the plurality of particles have preselected particle sizes within the range of about 25 micrometers and about 350 micrometers.

Supported embodiments include any of the foregoing methods, wherein the preselected porosity is within the range of about 5% and about 45%.

Supported embodiments include any of the foregoing methods, wherein the metal powder includes a metal selected from the group consisting of nickel and chromium.

Supported embodiments include any of the foregoing methods, further comprising: forming the ammonia gas distillation solution with a gas having a concentration of ammonia falling within the range of about 15% to about 45%.

Supported embodiments include any of the foregoing methods, wherein the predetermined period of time falls within the range of about eight hours and about forty-eight hours.

Supported embodiments include any of the foregoing methods, wherein the predetermined temperature falls within the range of about 500 degrees Celsius and about 750 degrees Celsius.

Supported embodiments include any of the foregoing methods, wherein the predetermined pressure falls within the range of about 500 millibars and about 5000 millibars.

Supported embodiments include any of the foregoing methods, further comprising: plating the metal part.

Supported embodiments include any of the foregoing methods, further comprising: plating the metal part with a metal selected from the group consisting of zinc, chromium, and nickel.

Supported embodiments include any of the foregoing methods, wherein the compacting step is performed by applying a pressure of between about 35 tons/sq in and about 75 tons/sq. in to the die.

Supported embodiments include an apparatus, a system, and/or means for implementing any of the foregoing methods or portions thereof.

Supported embodiments include any products produced by the foregoing methods.

Supported embodiments include a method of producing a hybrid washer, the method comprising: compacting a metal powder in a die to produce a preform having a preselected porosity with the metal powder containing iron and having a plurality of particles having a preselected particle sizes, carburizing the preform to produce a high carbon solution in the metal powder, contacting the preform with an ammonia gas distillation solution to inject nitrogen therein, heat treating the preform for a predetermined period of time at a predetermined temperature and at a predetermined pressure, and quenching the preform to form the hybrid washer.

Supported embodiments include the foregoing method, wherein the quenching step is an oil quenching step.

Supported embodiments include any of the foregoing methods, wherein the plurality of particles have preselected particle sizes within the range of about 25 micrometers and about 350 micrometers, and wherein the preselected porosity is within the range of about 5% and about 45%.

Supported embodiments include any of the foregoing methods, wherein the metal powder includes a metal selected from the group consisting of nickel and chromium.

Supported embodiments include any of the foregoing methods, further comprising: forming the ammonia gas distillation solution with a gas having a concentration of ammonia falling within the range of about 15% to about 45%.

Supported embodiments include any of the foregoing methods, wherein the predetermined period of time falls within the range of about eight hours and about forty-eight hours, wherein the predetermined temperature falls within the range of about 500 degrees Celsius and about 750 degrees Celsius, and wherein the predetermined pressure falls within the range of about 500 millibars and about 5000 millibars.

Supported embodiments include any of the foregoing methods, further comprising: plating the hybrid washer.

Supported embodiments include an apparatus, a system, and/or means for implementing any of the foregoing methods or portions thereof.

Supported embodiments can provide various attendant and/or technical advantages in terms of improved efficiency and/or savings with respect to providing a single washer than can function as both a conventional washer and as a locking washer. The washer can be particularly adapted for use in fastening systems in high vibration environments.

Supported embodiments include a hybrid washer that can be made through powder metallurgy processes to reduce or to eliminate waste material. Supported embodiments include a hybrid washer that can be made with metal powders that include a substantial amount of recycled material.

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible. The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A method of producing a metal part, the method comprising:
compacting a metal powder in a die to produce a preform having a preselected porosity with the metal powder containing iron and having a plurality of particles having a preselected particle sizes,
carburizing the preform to produce a high carbon solution in the metal powder, contacting the preform with an ammonia gas distillation solution to inject nitrogen therein,
heat treating the preform for a predetermined period of time at a predetermined
temperature and at a predetermined pressure, and
quenching the preform to form the metal part.

2. The method of claim 1, wherein the quenching step is an oil quenching step.

3. The method of claim 1, wherein the plurality of particles have preselected particle sizes within the range of about 25 micrometers and about 350 micrometers.

4. The method of claim 1, wherein the preselected porosity is within the range of about 5% and about 45%.

5. The method of claim 1, wherein the metal powder includes a metal selected from the group consisting of nickel and chromium.

6. The method of claim 1, further comprising:
forming the ammonia gas distillation solution with a gas having a concentration of ammonia falling within the range of about 15% to about 45%.

7. The method of claim 1, wherein the predetermined period of time falls within the range of about eight hours and about forty-eight hours.

8. The method of claim 1, wherein the predetermined temperature falls within the range of about 500 degrees Celsius and about 750 degrees Celsius.

9. The method of claim 1, wherein the predetermined pressure falls within the range of about 500 millibars and about 5000 millibars.

10. The method of claim 1, further comprising:
plating the metal part.

11. The method of claim 1, further comprising:
plating the metal part with a metal selected from the group consisting of zinc, chromium, and nickel.

12. The method of claim 1, wherein the compacting step is performed by applying a pressure of between about 35 tons/sq in and about 75 tons/sq. in to the die.

13. The product produced by the method of claim 1.

14. A method of producing a hybrid washer, the method comprising:
compacting a metal powder in a die to produce a preform having a preselected porosity with the metal powder containing iron and having a plurality of particles having a preselected particle sizes,
carburizing the preform to produce a high carbon solution in the metal powder,
contacting the preform with an ammonia gas distillation solution to inject nitrogen therein,
heat treating the preform for a predetermined period of time at a predetermined temperature and at a predetermined pressure, and
quenching the preform to form the hybrid washer.

15. The method of claim 14, wherein the quenching step is an oil quenching step.

16. The method of claim 14, wherein the plurality of particles have preselected particle sizes within the range of about 25 micrometers and about 350 micrometers, and wherein the preselected porosity is within the range of about 5% and about 45%.

17. The method of claim 14, wherein the metal powder includes a metal selected from the group consisting of nickel and chromium.

18. The method of claim 14, further comprising:
forming an engagement surface having a plurality of wedges on the hybrid washer.

19. The method of claim 14, further comprising:
plating the hybrid washer.

20. A hybrid washer produced in accordance with the method of claim 14.
